(19) United States
(12) Patent Application Publication
(10) Pub. No.: US 2021/0040918 A1
(43) Pub. Date: Feb. 11, 2021

(54) SYSTEM AND METHOD OF FILTERING A REFRIGERANT FOR A FLUID INJECTION SYSTEM FOR AN INTERNAL COMBUSTION ENGINE

(71) Applicant: Robert Bosch Limitada, Campinas SP (BR)

(72) Inventors: Marcello Francisco Brunocilla, Campinas SP (BR); Gustavo Santos Lopes, Campinas SP (BR); Glauco Bortolozzo, Campinas SP (BR)

(21) Appl. No.: 16/940,946

(22) Filed: Jul. 28, 2020

(30) Foreign Application Priority Data
Jul. 31, 2019 (BR) 102019015896-4

(51) Int. Cl. F02M 25/022; B01D 37/04; B01D 35/157; C02F 1/00; F28F 19/01; F28F 27/02

(52) U.S. Cl. CPC F02M 25/0222; B01D 37/04; B01D 35/1573; C02F 1/001; C02F 2103/023; F28F 19/01; F28F 27/02; B01D 2201/16; C02F 1/008

(57) ABSTRACT

The present invention refers to a system and a method of filtering a refrigerant for a fluid injection system of an internal combustion engine, the refrigerant being preferably water, by supplying tap water or any other source of water available in the vehicle, such as air conditioning and exhaust condensates, wherein such water must be clean, demineralized, deionized and mainly promptly available to be delivered to the water injection system at the instant the driver actuates the accelerator pedal to demand more power from the bi-fuel engine running on gasoline.

### BACKGROUND

The present invention refers to an embedded system and a method of filtering, purifying and sterilizing a refrigerant applied in fluid injection systems of internal combustion engines or even in cooling systems, preferably in engines used in motor vehicles, but not limited to embedded systems and applications thereof.

To mitigate the emission of greenhouse gases from automobiles and reduce the dependence on fossil fuels, several alternatives for substituting internal combustion engines are available. However, the best solution to this dilemma must take into account the country's geographical and socioeconomic characteristics, its energy matrix, emission regulations and the environmental impact of carbon fuel emissions throughout its life cycle.

Brazil has a strong reputation for its fleet of bi-fuel vehicles, long experience in the use of fuel ethanol and its distribution network. It sets Brazil apart from other global markets and justifies a unique approach to reduce CO₂ emissions.

However, there are limitations in the use of bi-fuel engines (popularly known as “flex” engines). To meet the demand for using two fuels in a single tank, regulation of a flex engine tends to be intermediate, as regulation of single-fuel engines is different depending on the use of either ethanol or gasoline fuel. This is because the vast majority of bi-fuel engines usually has a single geometric compression ratio, as this ratio is directly linked to the upward and downward movement of the pistons.

The piston reaches the upper and lower ends of its stroke, which are designated respectively Top Dead Center (TDC) and Bottom Dead Center (BDC).

As is known, the engine operation of passenger car has four strokes:

1. Intake

2. Compression

3. Combustion

4. Exhaust

The compression ratio is in the second stroke—the intake valves close after injection of the air/fuel mixture and it is compressed for combustion and exhaust to occur. Thus, the engine compression ratio is achieved: the ratio between the volume of the piston combustion chamber at the Bottom Dead Center (greatest volume) to the volume at the Top Dead Center (lowest volume).

Gasoline engines typically use lower ratios (typically between 8:1 and 12:1), while ethanol-powered engines work best at higher ratios (12:1 or even 14:1).

Bi-fuel engines operate at an intermediate ratio that can vary according to propellant manufacturers. Those who prioritize performance with gasoline, offering the option of using ethanol only for market reasons, choose lower ratios between 10:1 and 11.5:1. It can be noticed when power and torque values with both fuels are compared. For example, a propellant delivers 144 horsepower with ethanol and 141 with gasoline. However, consumption values are very high with alcohol (5.5 km/l) and good with gasoline (9 km/l).

As can be seen, performance with ethanol is impaired to the detriment of gasoline and using ethanol becomes advantageous only if the price drops greatly to values less than 65% of the price of gasoline, which condition is difficult to occur. Therefore, the driver tends to almost always fuel his vehicle with gasoline.

On the other hand, engines designed to work with ethanol use higher compression ratios of greater than 13:1. Since alcohol has higher resistance to detonation, it accepts greater compression without loss of performance. However, the drop in performance happens when the engine runs on gasoline, which is calibrated with reduced torque and power numbers to prevent detonation (engine knocking), which is extremely detrimental to engine durability. There is large variation in power and torque values in engines designed to run on ethanol; in an illustrative example, 111 horsepower for operation with ethanol and 104 horsepower for gasoline. Thus, it is feasible when the price of ethanol is 75% or up to 80% of that of the oil derivative, since consumption numbers are remarkably close with both fuels, such as 7.5 km/l (E) and 9.5 (G).

Thus, an improvement in the use of bi-fuel engines with advantages in fuel economy (when any fuel is used), increased performance and consequent reduction of CO₂ emissions are achieved by a bi-fuel engine (originally designed to operate with ethanol and propelled only with gasoline or any fuel mixture) by combining high compression ratio technology with the injection of a refrigerant.

It should be noted that the injection of refrigerant into internal combustion engines is an effective means of changing or reducing the detonation limits (to avoid knocking) of bi-fuel engines running on gasoline alone. The use of refrigerant injection allows an internal combustion propellant to be optimized when operated with ethanol, without loss of efficiency when also propelled with gasoline. A refrigerant can also be used in gasoline propelled engines subjected to detonation phenomena under more stringent conditions (supercharged engines, high compression ratios, racing engines, etc.) and also to protect their components.

In order to balance bi-fuel engines being propelled with both ethanol and gasoline, hence drawing more power and torque from the engine with lower fuel consumption and reduced emissions of pollutants during normal use (by increasing the consumption ratio between ethanol and gasoline above 69%, sometimes reaching 80%) a refrigerant fluid is injected (for example, water) into the engine during operation.

In order to efficiently obtain increased power from the engine associated with lower gasoline consumption and consequent reduction of emitted CO₂, the water to be injected must be free of contaminants, mineral salts (demineralized) and electrical charges (deionized). This condition is mandatory to prevent the internal components of the system from corroding, obstructing and clogging.

However, under the current conditions, the use of water commonly found in homes, water tanks and taps is not feasible for this type of application as it contains microcontaminants, solid impurities and mineral salts.

Microcontaminants, solid impurities and mineral salts found in water can cause serious damage to the refrigerant injection system. The high electrical conductivity from mineral salts can cause corrosion, component wearing and sediment deposition. Metal particles (“rust”) from the oxidation of residential water ducts, as well as the presence of sand, earth or additional inorganic elements (also from the water pipe) can lead to blockage of mechanical parts of the water injection system. In addition, the presence of biological agents can clog water lines and cause microbiological corrosion attack on plastics and metals.

For this application condition be reached, water must be pure, filtered and deionized. However, this type of water is known to not be easily found in emerging markets and, when found, is very expensive.

There exist inventions that enable the use of any type of water in water injection systems, including tap water. For example, document US 2019/0040819 discloses a system and method for storing and supplying water to be used in water injection systems of vehicles.

Said document describes a single tank for storing raw water, i.e. before the filtering process. The water is then forced through the filtration system via a suction pump that causes the raw water to move into a filter. This raw water advances through the filter passing through its filtering parts in order to complete the filtering process along a single path. As water filtration ends, this water that followed a direct flow reaches a line that leads to the water injection system, without any storage of the already clean water. The document also provides for the use of a water return line not used by the water tank injection system by means of a pressure regulator.

However, this type of application (refrigerant fluid injection systems) requires that filtered, demineralized and deionized water be immediately available to be used by the water injection system, since the vehicle is in motion and the detonation effect can occur at the exact instant the driver actuates the accelerator pedal to demand more power from the bi-fuel propellant running on gasoline. The fact that raw water still has to go through the filtration system when the injection system demands clean water may not prevent the occurrence of unwanted detonation.

In addition, it is important to know under which conditions the clean water is, that is, the water that has already passed through the filtration system. The desired conditions can include the current physical state of the clean water as well as whether the direct flow filtration was satisfactory or a refiltration of this water will be required so that it can meet the cleaning, demineralization and/or deionization conditions necessary not to prejudice the water injection system.

### SUMMARY

Thus, the present invention is intended to overcome all these drawbacks of prior techniques.

The present invention is intended to provide a system and method for filtering refrigerant fluid for a fluid injection system of an internal combustion engine, the refrigerant being preferably water, by supplying tap water or any other source of water available in the vehicle, such as air conditioning and exhaust condensates, wherein the water used by the injection system must be clean, demineralized and/or deionized and, mainly, immediately available to be delivered to the water injection system in the instant the driver actuates the accelerator pedal to demand more power from the bi-fuel engine running on gasoline. In addition, the present invention provides an increase in the power drawn from the engine associated with lower gasoline consumption and consequent reduction of CO₂ and other pollutant gas emissions by bi-fuel engines originally designed to be propelled with ethanol.

In order to overcome the drawbacks of the state of the art, the present invention describes a refrigerant fluid filtration system for a fluid injection system of an internal combustion engine, said filtration system comprising:
a fluid reservoir assembly provided with at least one fluid inlet port and a first reservoir to receive a refrigerant in raw state;
at least one filter medium comprising a filter inlet portion and a filter outlet portion, so that the filter medium inlet portion is in fluid association with the first reservoir to receive the refrigerant;
a first refrigerant conveying line provided with a first end associated with the fluid injection system;
at least one pump capable of increasing the pressure inside the first line and said fluid being conveyed within the first line;

wherein the fluid reservoir assembly comprises a second reservoir associated with the filter medium outlet portion and provided with a fluid outlet port in fluid association with a second end of the first line to supply the refrigerant to be conveyed to the fluid injection system.

In a first alternative embodiment, the present invention describes a refrigerant filtration system comprising a second line to convey the refrigerant, said second line comprising a first end associated with the first line, a second end associated with the fluid reservoir assembly to convey refrigerant to the fluid reservoir assembly and comprising at least a second pump capable of increasing the pressure inside the second line to cause the refrigerant to move inside the second line.

In a second alternative embodiment, the present invention describes a refrigerant filtration system where the second line comprises at least one first flow-directing valve placed to allow the refrigerant to be conveyed by the first line to the first end to be delivered to the fluid injection system if the internal combustion engine is running and to allow the refrigerant to be conveyed by the second line to the second end to be delivered to the first reservoir if the internal combustion engine is switched off.

In a third alternative embodiment, the present invention describes a refrigerant filtration system where the first line comprises at least one fluid pressure regulating device in fluid association with the fluid reservoir assembly.

In a fourth alternative embodiment, the present invention describes a refrigerant filtration system where the refrigerant filtration system comprises at least one sensor capable of detecting the actual condition of the refrigerant.

In a fifth alternative embodiment, the present invention describes a refrigerant filtration system wherein said refrigerant filtration system comprises a third line to convey the refrigerant, said third line being provided with a first end associated with a second flow-directing valve and in fluid association with the first line and a second end, the second flow-directing valve in fluid association with the first line to allow refrigerant to be conveyed from the first end of the third line to the second end of the third line to be delivered to the filter inlet portion of the filter medium.

Moreover, the present invention describes a method of filtering a refrigerant for a refrigerant filtration system of a fluid injection system for an internal combustion engine comprising:
a fluid reservoir assembly provided with at least one fluid inlet port and a first reservoir to receive a refrigerant in raw state;
at least one filter medium comprising a filter inlet portion and a filter outlet portion, so that the filter medium inlet portion is in fluid association with the first reservoir to receive the refrigerant;
a first refrigerant conveying line provided with a first end associated with the fluid injection system;
at least one pump capable of increasing the pressure inside the first line and said fluid being conveyed inside the first line;

wherein the said method comprises the steps of:
providing the refrigerant in raw state, said provision being made by the fluid inlet port;
forcing the refrigerant into the filter inlet portion;
filtering the refrigerant through the filter medium;
storing the refrigerant that comes from the filter medium through the filter outlet port inside a second reservoir, making said refrigerant available to be delivered to the fluid injection system;
conveying the refrigerant from the second reservoir to the fluid injection system, said fluid passing through the flow-directing valve.

In a second alternative embodiment, the present invention describes a refrigerant filtration method comprising the steps of:
acquiring the actual condition of the refrigerant stored inside the second reservoir using at least one sensor;
evaluating the actual condition of the refrigerant stored inside the second reservoir;
placing the first flow-directing valve to allow the refrigerant to be delivered to the fluid injection system or to the first reservoir.

In a third alternative embodiment, the present invention describes a refrigerant filtration method comprising the steps of:
acquiring the actual physical state of the refrigerant stored inside the second reservoir using at least one sensor;
sending at least one signal to a control unit, said signal containing the actual physical state of the refrigerant stored inside the second reservoir;
determining an action on the refrigerant stored inside the second reservoir;
performing the action on the refrigerant stored inside the second reservoir.

In a fourth alternative embodiment, the present invention describes a refrigerant filtration method comprising the steps of:
acquiring the actual electrical conductivity of the refrigerant stored inside the second reservoir using at least one sensor;
sending at least one signal to a control unit, said signal containing the actual electrical conductivity of the refrigerant stored inside the second reservoir;
processing the signal from the refrigerant in the control unit;
determining the position of the second flow-directing valve;
placing the second flow-directing valve to allow said refrigerant to be conveyed inside the first line from the second end to the first end to be delivered to the fluid injection system or conveyed inside the third line from the first end to the second end to be delivered to the filter medium inlet portion.

### BRIEF DESCRIPTION OF THE DRAWINGS

FIG. 1—Schematic representation of the preferred embodiment of the present invention.

FIG. 2—First schematic representation of the alternative embodiment of the present invention.

### DETAILED DESCRIPTION

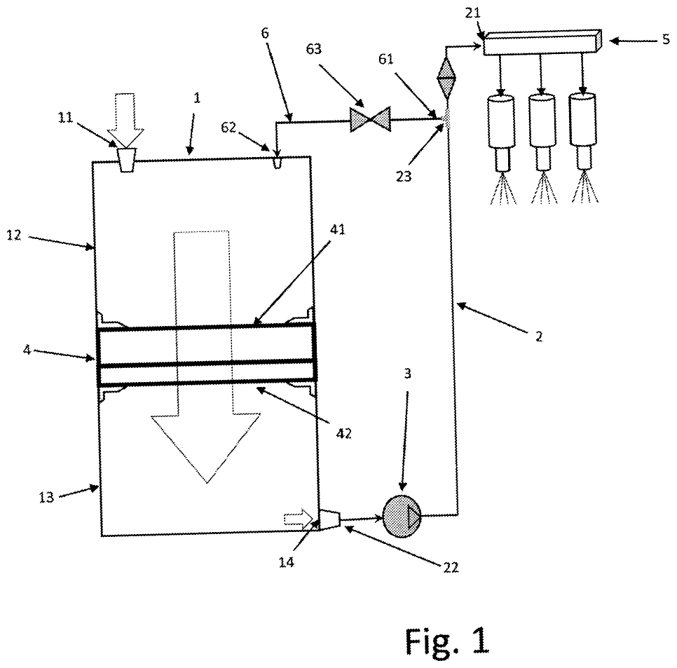

As seen in FIG. 1, the present invention describes a refrigerant fluid filtration system for a fluid injection system of an internal combustion engine.

For bi-fuel engines achieve a balance when being propelled with both ethanol and gasoline, hence drawing more power and torque from the engine with lower fuel consumption and reduced emissions of pollutants during normal use (by increasing the consumption ratio between ethanol and gasoline above 69%, sometimes reaching 80%) a refrigerant fluid is injected (for example, water) into the engine during operation.

Thus, in order to efficiently draw more power from the engine while consuming less gasoline and, accordingly, reducing the CO₂ emissions, the water to be injected must be free of contaminants, mineral salts (demineralized) and electrical charges (deionized). This condition is mandatory to prevent the internal components of the system from corroding, obstructing and clogging.

However, under the current conditions, the use of water commonly found in homes, water tanks and taps is not feasible for this type of application as it contains microcontaminants and mineral salts.

For this condition be reached, water must be pure, filtered and deionized. However, this type of water is known to not be easily found and, when found, is very expensive.

However, this type of application requires water to be filtered, demineralized and/or deionized and that it be immediately available to be used by the water injection system, since the vehicle is in motion and the detonation effect can occur at the exact instant the driver actuates the accelerator pedal to demand more power from the bi-fuel propellant running on gasoline. The fact that raw water still has to go through the filtration system when the injection system demands clean water may not prevent the occurrence of unwanted detonation.

In addition, it is important to know under which conditions the clean water is, that is, the water that has already passed through the filtration system. The desired conditions can include the current physical state of the clean water as well as whether the direct flow filtration was satisfactory or a refiltration of this water will be required so that it can meet the cleaning, demineralization and deionization conditions necessary not to prejudice the water injection system.

Therefore, FIG. 1 describes the invention as a refrigerant filtration system for a fluid injection system of an internal combustion engine, said filtration system comprising:
a fluid reservoir assembly 1 provided with at least one fluid inlet port 11 and a first reservoir 12 to receive a refrigerant in raw state;
at least one filter medium 4 comprising a filter inlet portion 41 and a filter outlet portion 42, so that the filter medium 4 inlet portion 41 is in fluid association with the first reservoir 12 to receive the refrigerant;
a first refrigerant conveying line 2 provided with a first end 21 associated with the fluid injection system 5;
at least one pump 3 capable of increasing the pressure inside the first line 2 and said fluid being conveyed inside the first line 2;

wherein the fluid reservoir assembly 1 comprises a second reservoir 13 associated with the filter medium 4 outlet portion 42 and provided with a fluid outlet port 14 in fluid association with a second end 22 of the first line 2 to supply the refrigerant to be conveyed to the fluid injection system 5.

In this instance, a fluid injection system is preferably meant to be a system capable of injecting a refrigerant into the engine during its operation to reduce the temperature of the combustion chamber and prevent the detonation effect, also known as knocking. Alternatively, however, the fluid injection system is understood as any other system capable of cooling the engine temperature, such as radiators.

Also, the refrigerant is understood as water, more preferably tap water. However, the refrigerant may also comprise any fluid substance either pure or combined with another fluid substance that is preferably used in fluid injection systems for the purpose of being injected into the engine or alternatively for cooling the engine and can be applied in another system capable of cooling the engine, such as radiators.

As can also be seen in FIG. 1, a filter medium 4 is preferably understood as a set of filters arranged sequentially, being provided with a dirty fluid inlet region and a fluid outlet region, for the purpose of retaining at least one of the following contaminants: large particles, fine particles, biocontaminants, metallic particulates, mineral salts and positive and/or negative ionic charges. Alternatively, however, the filter medium 4 may comprise a single filter capable of retaining at least one of the aforementioned contaminants.

According to FIG. 1, a refrigerant conveying line is meant to be least one pipe or hose duct capable of transporting water from one point to another within it.

Additionally, a pump is meant to be any device capable of causing the movement of a fluid by generating vacuum.

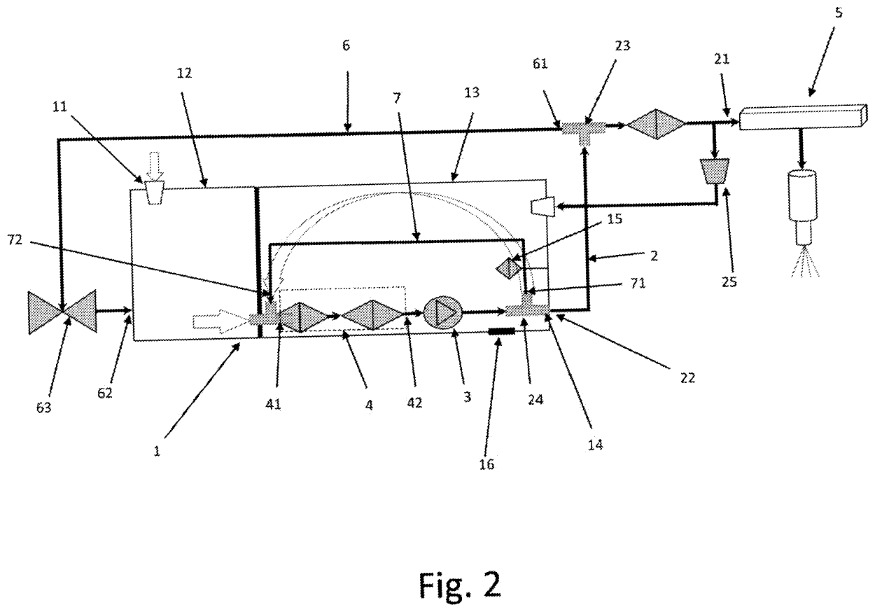

Also, according to FIGS. 1 and 2, the fluid outlet port 14 comprises a region of the second reservoir 13 that is associated with the second end 22 of the first line 2 through a valve, a hatch, a gate or any other means to control and/or direct the flow of refrigerant at that point, or may be directly associated with the second end 22 of the first line 2.

In an alternative embodiment, the present invention describes a refrigerant filtration system, wherein said refrigerant filtration system comprises a second line 6 to convey the refrigerant, said second line 6 comprising a first end 61 associated with the first line 2, a second end 62 associated with the fluid reservoir assembly 1 to convey refrigerant to the fluid reservoir assembly 1 and comprising at least a second pump 63 capable of increasing the pressure inside the second line 6 to cause the refrigerant to move inside the second line 6.

In another alternative embodiment, the present invention describes a refrigerant filtration system wherein the second line 6 comprises at least one first flow-directing valve 23 placed to allow the refrigerant to be conveyed by the first line 2 to the first end 21 to be delivered to the fluid injection system 5 if the internal combustion engine is running and to allow the refrigerant to be conveyed by the second line 6 to the second end 62 to be delivered to the first reservoir 12 if the internal combustion engine is switched off.

It should be noted that a flow-directing valve is understood as a two-way valve or over that directs the flow of a fluid running through its interior, so as to interrupt it in one direction and enable said flow to go to at least another direction.

In another alternative embodiment, the present invention describes a refrigerant filtration system, wherein the first line 2 comprises at least one fluid pressure regulating device 25 associated with the first line 2 and fluidly attached to the fluid reservoir assembly 1.

Any apparatus, preferably, an apparatus provided with a membrane, that is capable of regulating the pressure inside a fluid conveying line in the event the internal pressure rises can be understood as a pressure regulating device.

In another alternative embodiment, the present invention further describes a refrigerant filtration system comprising at least one sensor 15 capable of detecting the actual condition of the refrigerant. The actual condition as meant to be the actual physical state of the clean water. The actual condition can also mean the detection of the presence of some type of particle in the fluid: large particles, fine particles, biocontaminants, metallic particulates, mineral salts and positive and/or negative ionic charges. Thus, one can assert whether direct flow filtration was satisfactory or a refiltration of the fluid will be required.

In another alternative embodiment, the present invention further describes a refrigerant filtration system comprising a third line 7 to convey the refrigerant, said third line 7 being provided with a first end 71 fluidly associated with the first line 2 and a second end 62 associated with a second flow-directing valve 24, the second flow directing valve 24 being in fluid association with the first line 2 to allow the refrigerant to be conveyed from the first end 71 of the third line 7 to the second end 72 of the third line 7 to be delivered to the filter inlet portion 41 of the filter medium 4.

Thus, the present invention is intended to provide a refrigerant filtering system for a fluid injection system of an internal combustion engine, preferably the refrigerant being preferably water, by supplying tap water or any other source of water available in the vehicle, such as air conditioning and exhaust condensates, wherein such water must be clean, demineralized and/or deionized and, mainly, promptly available to be delivered to the water injection system 5 in the instant the driver actuates the accelerator pedal to demand more power from the bi-fuel engine running on gasoline.

Moreover, the present invention further describes a method of filtering a refrigerant for a refrigerant filtration system of a fluid injection system for an internal combustion engine comprising:
a fluid reservoir assembly 1 provided with at least one fluid inlet port 11 and a first reservoir 12 to receive a refrigerant in raw state;
at least one filter medium 4 comprising a filter inlet portion 41 and a filter outlet portion 42, so that the filter medium 4 inlet portion 41 is in fluid association with the first reservoir 12 to receive the refrigerant;
a first refrigerant conveying line 2 provided with a first end 21 associated with the fluid injection system 5;
at least one pump 3 capable of increasing the pressure inside the first line 2 and said fluid being conveyed inside the first line 2;

wherein the said method comprises the steps of:
providing the refrigerant in raw state, said provision being made by the fluid inlet port 11;
forcing the refrigerant into the filter inlet portion 41;
filtering the refrigerant through the filter medium 4;
storing the refrigerant that comes from the filter medium 4 through the filter outlet port 42 inside a second reservoir 13, making said refrigerant available to be delivered to the fluid injection system 5;
pumping the refrigerant from the second reservoir 13 to the fluid injection system 5, said fluid passing through the flow-directing valve 23.

The provision of refrigerant can be made by supplying tap water. Alternatively, the provision of refrigerant can be made by supplying water from the vehicle air conditioning system, or from the vehicle exhaust system.

The action of forcing the refrigerant into the filter inlet portion 41 can be made by gravity, by a vacuum generated by a pump 3, a plunger placed inside the first reservoir 12 or any other means not limited to those described herein.

Additionally, pumping is meant to be any action performed by a suction pump or any other device capable of causing a fluid to move by generating vacuum.

Alternatively, the present invention further describes a refrigerant filtration method comprising the steps of:
acquiring the actual condition of the refrigerant stored inside the second reservoir 13 using at least one sensor 15;
evaluating the actual condition of the refrigerant stored inside the second reservoir 13;
determining the position of the flow-directing valve 23;
placing the flow-directing valve 23 to allow the refrigerant to be delivered to the fluid injection system 5 or to the first reservoir 12.

The actual condition is meant to be the actual physical state of the clean fluid. The actual condition can also mean the detection of the presence of some type of particle in the fluid: large particles, fine particles, biocontaminants, metallic particulates, mineral salts and positive and/or negative ionic charges.

Alternatively, the present invention further describes another alternative embodiment of a refrigerant filtration method comprising the steps of:
acquiring the actual physical state of the refrigerant stored inside the second reservoir 13 using at least one sensor 15;
sending at least one signal to a control unit, said signal containing the actual physical state of the refrigerant stored inside the second reservoir 13;
processing the signal from the refrigerant in the control unit;
determining an action on the refrigerant stored inside the second reservoir 13;
performing the action on the refrigerant stored inside the second reservoir 13.

A control unit can be understood as an electronic unit for monitoring and controlling vehicle's operating parameters. Said control unit can be unique to control the water filtration system, can be dedicated exclusively to the fluid injection system as a whole, or can even be the electronic control unit already present in the vehicle.

An action on the refrigerant is preferably understood as the application of an electrical power capable of thawing the refrigerant in case said fluid has frozen due to low temperatures of the environment where the vehicle is located.

Thus, the present invention further describes another alternative embodiment of a refrigerant filtration method comprising the steps of:
acquiring the actual electrical conductivity of the refrigerant stored inside the second reservoir 13 using at least one sensor 15;
sending at least one signal to a control unit, said signal containing the actual electrical conductivity of the refrigerant stored inside the second reservoir 13;
processing the signal from the refrigerant in the control unit;
determining the position of the second flow-directing valve 24;
placing the second flow-directing valve 24 to allow said refrigerant to be conveyed and delivered to the fluid injection system 5 or conveyed inside the third line 7 from the first end 71 to the second end 72 to be delivered to the filter medium 5 inlet portion 41.

Also, a flow-directing valve is understood as a two-way valve or over that directs the flow of a fluid running through its interior, so as to interrupt it in one direction and enable said flow to go to at least another direction.

Thus, it should be noted that, as discussed above, the present invention provides a method of filtering a refrigerant for a fluid injection system of an internal combustion engine, the refrigerant being preferably water, by supplying tap water or any other source of water available in the vehicle, such as air conditioning and exhaust condensates, wherein such water must be clean, demineralized, deionized and, mainly, promptly available to be delivered to the water injection system 5 in the instant the driver actuates the accelerator pedal to demand more power from the bi-fuel engine running on gasoline.

Thus, the present invention also provides an increase in the power drawn from the engine associated with lower gasoline consumption and consequent reduction of CO₂ and other pollutant gas emissions by bi-fuel engines originally designed to be propelled with ethanol.

Accordingly, the present invention refers to an embedded system, but it is understood that its application is not limited to embedded systems and can be applied to a non-embedded system, such as a refrigerant filtration, purification and sterilization station applicable in fluid injection systems for internal combustion engines.

1. A refrigerant filtration system for a fluid injection system of an internal combustion engine, said filtration system comprising:
a fluid reservoir assembly (1) provided with at least one fluid inlet port (11) and a first reservoir (12) to receive a refrigerant in raw state;
at least one filter medium (4) comprising a filter inlet portion (41) and a filter outlet portion (42), so that the filter medium (4) inlet portion (41) is in fluid association with the first reservoir (12) to receive the refrigerant;
a first refrigerant conveying line (2) provided with a first end (21) associated with the fluid injection system (5);
at least one pump (3) capable of increasing the pressure inside the first line (2) and said fluid being conveyed inside the first line (2);
characterized in that the fluid reservoir assembly (1) comprises a second reservoir (13) associated with the filter medium (4) outlet portion (42) and provided with a fluid outlet port (14) in fluid association with a second end (22) of the first line (2) to supply the refrigerant to be conveyed to the fluid injection system (5).

2. The refrigerant filtration system of claim 1, characterized in that the refrigerant filtration system comprises a second line (6) to convey the refrigerant, said second line (6) comprising a first end (61) associated with the first line (2), a second end (62) associated with the fluid reservoir assembly (1) to convey refrigerant to the fluid reservoir assembly (1) and comprising at least a second pump (63) capable of increasing the pressure inside the second line (6) to cause the refrigerant to move inside the second line (6).

3. The refrigerant filtration system of claim 2, characterized in that the second line (6) comprises at least one first flow-directing valve (23) placed to allow the refrigerant to be conveyed by the first line (2) to the first end (21) to be delivered to the fluid injection system (5) if the internal combustion engine is running and to allow the refrigerant to be conveyed by the second line (6) to the second end (62) to be delivered to the first reservoir (12) if the internal combustion engine is switched off.

4. The refrigerant filtration system of claim 1, characterized in that the first line (2) comprises at least one fluid pressure regulating device (25) associated with the first line (2) and fluidly attached to the fluid reservoir assembly (1).

5. The refrigerant filtration system of claim 1, characterized in that the refrigerant filtration system comprises at least one sensor (15) capable of detecting the actual condition of the refrigerant.

6. The refrigerant filtration system of claim 1, characterized in that the refrigerant filtration system comprises a third line (7) to convey the refrigerant, said third line (7) being provided with a first end (71) associated with a second flow-directing valve (24) in fluid association with the first line (2) and a second end (72), the second flow-directing valve (24) in fluid association with the first line (2) to allow the refrigerant to be conveyed from the first end (71) of the third line (7) to the second end (72) of the third line (7) to be delivered to the filter inlet portion (41) of the filter medium (4).

7. A method of filtering a refrigerant for a refrigerant filtration system of a fluid injection system for an internal combustion engine comprising:
a fluid reservoir assembly (1) provided with at least one fluid inlet port (11) and a first reservoir (12) to receive a refrigerant in raw state;
at least one filter medium (4) comprising a filter inlet portion (41) and a filter outlet portion (42), so that the filter medium (4) inlet portion (41) is in fluid association with the first reservoir (12) to receive the refrigerant;
a first refrigerant conveying line (2) provided with a first end (21) associated with the fluid injection system (5);
at least one pump (3) capable of increasing the pressure inside the first line (2) and said fluid being conveyed inside the first line (2);
characterized in that said method comprises the steps of:
providing the refrigerant in raw state, said provision being made by the fluid inlet port (11);
forcing the refrigerant into the filter inlet portion (41);
filtering the refrigerant through the filter medium (4);
storing the refrigerant that comes from the filter medium (4) through the filter outlet port (42) inside a second reservoir (13), making said refrigerant available to be delivered to the fluid injection system (5);
conveying the refrigerant from the second reservoir (13) to the fluid injection system (5), said fluid passing through the flow-directing valve (23).

8. The refrigerant filtration method of claim 7, characterized in it comprises the steps of:
acquiring the actual condition of the refrigerant stored inside the second reservoir (13) using at least one sensor (15);
evaluating the actual condition of the refrigerant stored inside the second reservoir (13);
determining the position of the flow-directing valve (23);
placing the flow-directing valve (23) to allow the refrigerant to be delivered to the fluid injection system (5) or to the first reservoir (12).

9. The refrigerant filtration method of claim 8, characterized in that it comprises the steps of:
acquiring the actual physical state of the refrigerant stored inside the second reservoir (13) using at least one sensor (15);
sending at least one signal to a control unit, said signal containing the actual physical state of the refrigerant stored inside the second reservoir (13);
processing the signal from the refrigerant in the control unit;
determining an action on the refrigerant stored inside the second reservoir (13);
performing the action on the refrigerant stored inside the second reservoir (13).

10. The refrigerant filtration method of claim 7, characterized in that it comprises the steps of:
acquiring the actual electrical conductivity of the refrigerant stored inside the second reservoir (13) using at least one sensor (15);
sending at least one signal to a control unit, said signal containing the actual electrical conductivity of the refrigerant stored inside the second reservoir (13);
processing the signal from the refrigerant in the control unit;
determining the position of the second flow-directing valve (24);
placing the second flow-directing valve (24) to allow said refrigerant to be conveyed inside the first line (2) from the second end (22) to the first end (21) to be delivered to the fluid injection system (5) or be conveyed inside the third line (7) from the first end (71) to the second end (72) to be delivered to the filter medium (4) inlet portion (41).
